(19) United States
(12) Patent Application Publication
(10) Pub. No.: US 2011/0296956 A1
(43) Pub. Date: Dec. 8, 2011

(54) Opener to Lift a Tab of an Easy-Open Can

(76) Inventor: Miin-Tsang SHEU, Changhua City (TW)

(21) Appl. No.: 12/792,811

(22) Filed: Jun. 3, 2010

(51) Int. Cl. B67B 7/00

(52) U.S. Cl. 81/3.57

(57) ABSTRACT

An opener to lift a tab of an easy-open can comprises a long-narrow lifting shaft whose front end disposes a keen prying section. A ring handle at a top rear section of the prying section is extensively disposed upward, and a thin protecting plate is extensively disposed outward for providing a protecting function. The keen prying section is inserted into a top edge of an opening of the tab. Thereby, a front portion of the lifting shaft stretches beyond one side of the easy-open can for forming a fulcrum. An upward pulling from users allows a front end of the tab to break the top lid of the easy-open can for forming an infirm breach on one section of the top lid. Further by means of a rear portion of the lifting shaft striding across a correspondent side of the easy-open can for forming the other fulcrum, an opposite and upward pulling force on the ring handle allows the rising prying section to lift the tab. Thus, the entire top lid of the easy-open can could be smoothly pulled apart and discarded. Thereby, by means of the leverage, a simplified process via a pressing and a pulling permits a speedy operation to open the can with an effort-saving effect.

### BACKGROUND OF THE INVENTION

1. Field of the Invention

The present invention relates to an opener to lift a tab of an easy-open can comprising a long-narrow lifting shaft whose front end disposes a keen prying section, which combines with a ring handle extending upward from a top rear section of the prying section for users to hold with and cooperates a thin protecting plate extending outward from two sides of a middle rear section of the prying section for providing a protection to a bottom portion of users' hand. Therefore, the present invention provides an opener which permits users to grasp by hands and to achieve a simple operation by the inserting, stretching, pressing, and pulling, thereby attaining a speedy, safe, and effort-saving appliance for lifting the tab and opening the can.

2. Description of the Related Art

Generally, the sealing manner of the traditional can is to directly seal the can on a top lid and a bottom lid, the opening of which relies on either a manual can opener or an electric can opener to cut around the top lid of the can. Afore operation is in fact strenuous and time-consuming, and adversely, an inner edge of the opening of the can inclines to an indented rim with an uneven border in view of the traditional cutting manner. Thus, such jagged margin subjects users to an incised wound. Therefore, there is also a can utilizing its top lid disposing with a tab at one side thereof to allow users to pull the tab and lift the top lid for opening. Such means of breaking the sealing at first and thence pulling as well as lifting the top lid conduce to an easy-open can.

However, the operation to open and depart the top lid from the easy-open can requires users to employ their fingers to insert into an opening formed at a rear end of the tab. Thereby, upwardly pulling the tab allows a front end of the tab to press downward, so that one side of the top lid is split with a breach. Thence, the tab is upwardly pulled along an opposite direction, and the top lid completely comes off a top opening of the easy-open can. Nonetheless, the tab is originally lying flat on the top lid, which is unfavorable for the insertion of a finger end or a nail. Moreover, the pulling force to the tab has to be larger than the rigidity of the tab, so that the easy-open can be opened or the top lid could entirely come off the easy-open can. Evidently, directly pulling the tab is rather strenuous, so the elders, the weak, or the children might be unable to operate such easy-open can. Besides, users' nails are subjected to snap, or users' fingers might hurt. Especially, since the top lid usually adopts a thin iron sheet, the departure of the top lid from the edge of the easy-open can readily results in a sharp rim. Herein, in time of pulling the tab, users' exposed hands might directly touch the sharp rim of the top lid so as to be slashed. As a result, although the easy-open can is free from an opener and conduces to an even opening edge, the relative additional disadvantages should not be neglected.

### SUMMARY OF THE INVENTION

The object of the present invention is to provide an opener to lift a tab of an easy-open can with an effort-saving effect. The invention comprises a long-narrow lifting shaft whose front end disposes a keen prying section. Cooperating a ring handle at a top rear section of the prying section for users to hold allows the keen prying section to insert into a top edge of an opening of the tab. Thereby, a front portion of the lifting shaft stretches beyond one side of the easy-open can. Alternatively, a rear portion of the lifting shaft strides across an opposite side of the easy-open can for forming a fulcrum. An upward pulling or an opposite pulling from users' holding on the ring handle allows a front end of the tab to break the top lid of the easy-open can for forming an infirm breach. As it should be, a rising prying section is able to prize the tab so as to smoothly pull the entire top lid of the easy-open can apart and discard the top lid. Thereby, by means of the leverage, a simplified process of pressing and then pulling permits a speedy operation to open the can. Thus, users could conveniently and easily open the can, which suits to the practical application.

Another object of the present invention is to provide an opener to lift a tab of an easy-open can that could protect users. Wherein, the insertion of the keen prying section of the long-narrow lifting shaft into the top edge of the opening of the tab conduces to prizing and pulling the top lid. Such opener further cooperates with a ring handle and a protecting plate disposed at a lower section for protecting of the bottom side of users' hand. As a result, the present invention keeps users' hand from touching the top lid and prevents from slashing the hand to guarantee the using safety.

### BRIEF DESCRIPTION OF THE DRAWINGS

FIG. 1 is a perspective view of the present invention;

FIG. 1-A is an exploded view showing the present invention;

FIG. 1-B is a reversed perspective view of the present invention;

FIG. 2 is another perspective view showing another preferred embodiment of the present invention;

FIG. 2-A is another reversed perspective view showing another preferred embodiment of the present invention;

FIG. 3 is a schematic view showing the present invention being held; and

FIGS. 4-A, B, C are schematic views showing the present invention in use.

### DETAILED DESCRIPTION OF THE PREFERRED EMBODIMENTS

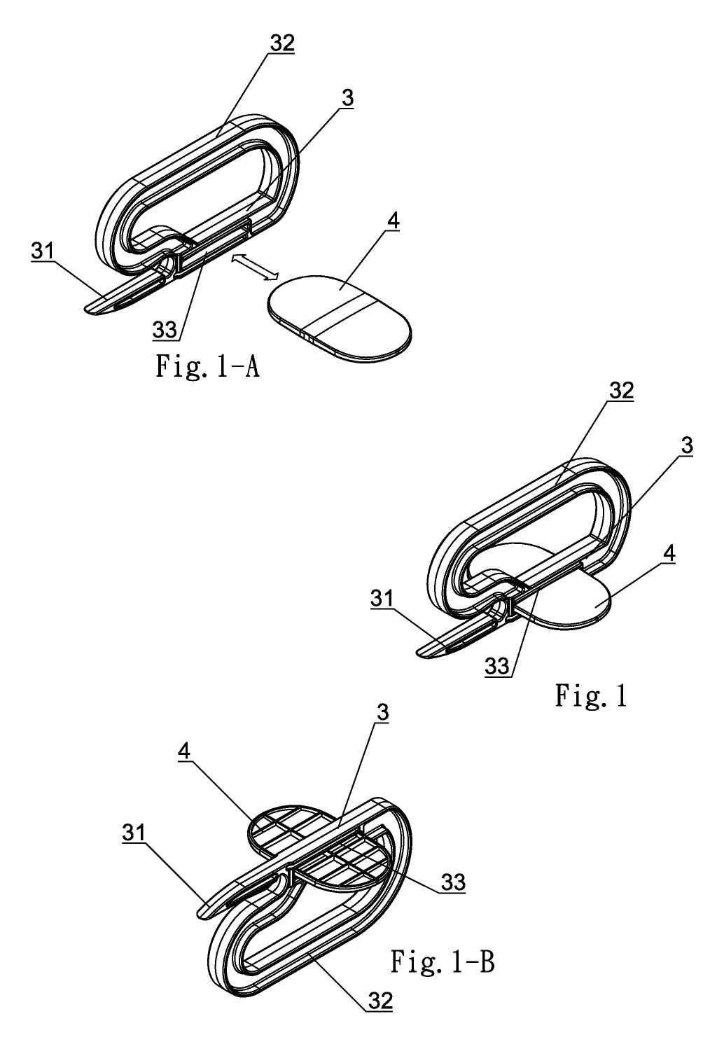

Referring to FIGS. 1, 1-A, and 1-B, an opener to lift a tab of an easy-open can comprises a long-narrow lifting shaft 3 whose front end disposes a keen prying section 31. Wherein, at a top rear section of the prying section 31, a ring handle 32 is extensively disposed upward for users to hold (as shown in FIG. 3). At two sides of a middle rear section of the prying section 31, a thin protecting plate 4 is extensively disposed outward for providing a protection to a bottom portion of users' hand H.

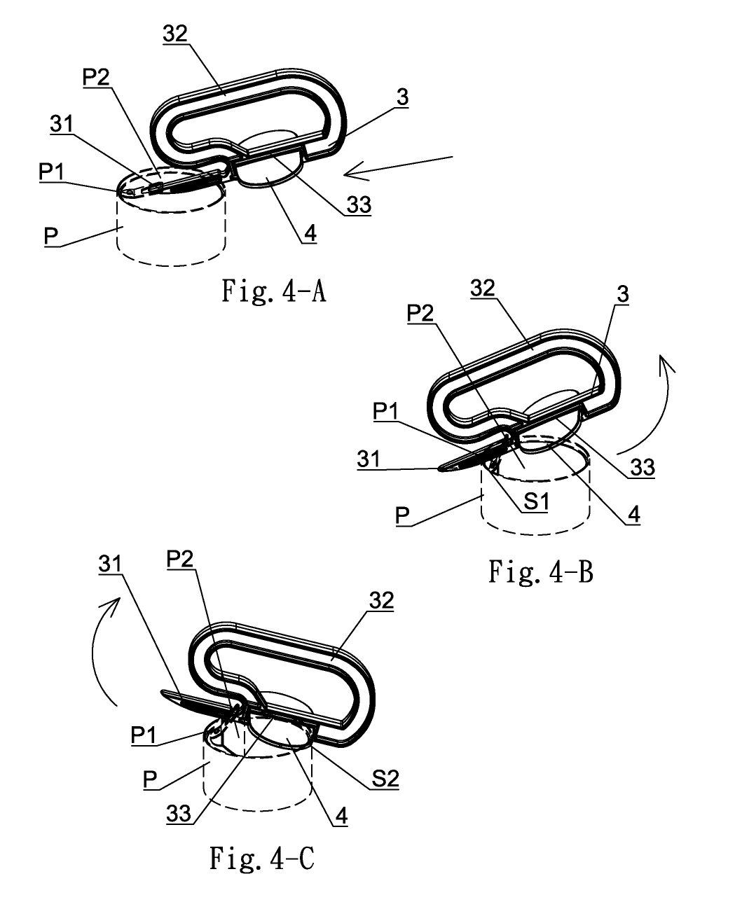

A prying from the keen prying section 31 to a top edge of an opening of the tab P2 (as shown in FIG. 4-A) allows a front section of the lifting shaft 3 to stretch beyond a side of the easy-open can P for forming a fulcrum S1, thereby permitting users to pull the ring handle 32 toward a top front. A pressure is imparted from a front end of the tab P2 to have a section of the top lid P1 of the easy-open can P sink for forming an infirm breach (as shown in FIG. 4-B). A rear section of the lifting shaft 3 striding across the other symmetrical side of the easy-open can P forms another fulcrum S2. Reverse pulling the ring handle 32 upward from users allows the rising prying section 31 to prize the tab P2 (as shown in FIG. 4-C), so as to entirely pull the top lid P1 of the easy-open can P apart depart the top lid P1 therefrom and then discard the top lid P1.

Thereby, by means of the leverage, a simplified process of pressing and then pulling conduces to an easy operation. Users' hand H is protected by the protecting plate 4, rather than incised by the sharp edge of the top lid P1. Moreover, during the prying, users' hand H does not have to touch the top lid P1. As a result, an effort-saving and speedy operation is achieved for suiting to the practical application.

In addition, the handling position of users' hand on the ring handle 32 is shown in FIG. 3. By means of the ring handle 32 formed with a frontward-extensive formation, a holding of the users and a force imparting position beyond the opening of the tab P2 are allowed, so that a more effort-saving operation is accomplished.

Further referring to FIGS. 1, 1-A, and 1-B, the thin protecting plate 4, which is extended outward from two sides of the middle section of the lifting shaft 3 for protecting the bottom of the user's hand H in time of holding the ring handle 32, could be alternatively structured as an independent formation for being cooperatively inserted into a slot or a niche at a bottom side corresponding to the lifting shaft 3. A correspondent position of the lifting shaft 3 is defined with a slot 33 (or a niche at a bottom side) for the protecting plate 4 to insert. Alternatively, the slot 33 that is designed in accordance with a contour of a cross section of the protecting plate 4 is able to be embedded by the protecting plate 4. Thereby, the insertion or the embedding of the protecting plate 4 allows a lower portion of the lifting shaft 3 to spread toward two sides, so that the user's hand H is separated from touching the top lid P1 during the operation. Further, the separated protecting plate 4 is able to lean against the lifting shaft 3 flat for diminishing the wrapping dimension of the product before using. Thus, the configuration in accordance with the present invention does not occupy much space, which saves the freight.

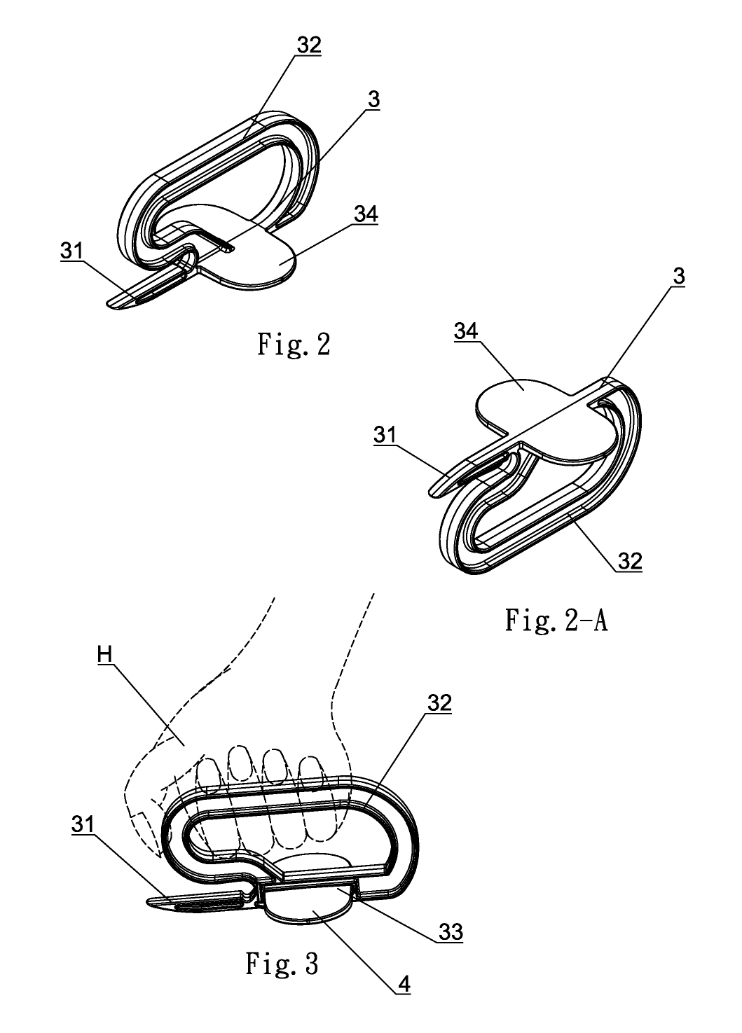

Referring to FIGS. 2 and 2-A, the thin protecting plate 34 that is disposed at two sides of the middle section of the lifting shaft 3 and extended outward therefrom adopts an integral formation with the lifting shaft 3. Similarly, a lower portion of the lifting shaft 3 spreads toward two sides, so that the user's hand H is separated from touching the top lid P1 during the operation. The integral arrangement of the protecting plate 34 simplifies the manufacture of the structure preferably decreases the cost, prevents the loss, and promotes the using strength of the practical application.

Although particular embodiments of the present invention have been described in detail for purposes of illustration, various modifications and enhancements may be made without departing from the spirit and scope of the present invention. Accordingly, the present invention is not to be limited except as by the appended claims.

I claim:

1. An opener to lift a tab of an easy-open can comprising a long-narrow lifting shaft whose front end disposes a keen prying section; wherein, at a top rear section of said prying section, a ring handle being extensively disposed upward for users to hold; at two sides of a middle rear section of said prying section, a thin protecting plate being extensively disposed outward for providing a protection to a bottom portion of users' hand; a prying from said keen prying section to a top edge of an opening of said tab allowing a front section of said lifting shaft to stretch beyond a side of said easy-open can for forming a fulcrum, thereby permitting users to pull said ring handle toward a top front; a pressure being imparted from a front end of said tab to have a section of said top lid sink for forming an infirm breach; a rear section of said lifting shaft striding across the other symmetrical side of said easy-open can forming another fulcrum; a reverse pulling said ring handle upward from users allowing said prying section which is risen to prize said tab; entirely pulling said top lid of said easy-open can apart and permitting said top lid to depart therefrom and then discard for completing an opening of said can.

2. The opener as claimed in claim 1, wherein, said thin protecting plate that is extended outward from two sides of said middle section of said lifting shaft is alternatively structured as an independent formation for being cooperatively inserted into a slot or a niche at a bottom side corresponding to said lifting shaft; a contour of said slot or said niche is designed in accordance with a contour of a cross section of said protecting plate; thereby, an insertion or an embedding of said protecting plate allows a lower portion of said lifting shaft to spread toward two sides, so that said hand of users' is separated from touching said top lid during the operation.

3. The opener as claimed in claim 1, wherein, said thin protecting plate that is disposed at two sides of said middle section of said lifting shaft and extended outward therefrom adopts an integral arrangement with said lifting shaft; thereby, a lower portion of said lifting shaft spreads toward two sides, so that said hand of users' is separated from touching said top lid during the operation.

4. The opener as claimed in claim 1, wherein, said ring handle is formed with a frontward-extensive arrangement, thereby allowing a holding of the users and a force imparting position beyond said opening of said tab to be achieved, so that an effort-saving operation is accomplished.
